(19) United States
(12) Patent Application Publication
(10) Pub. No.: US 2012/0122432 A1
(43) Pub. Date: May 17, 2012

(54) System, Method and Computer Program for Determining the Probability of a Medical Event Occurring

(75) Inventors: Rinaldo Bellomo, Victoria (AU); Graeme Keith Hart, Victoria (AU); James Alexander Bailey, Victoria (AU); Elsa Loekito, Victoria (AU)

(73) Assignee: Smart Internet Technology CRC Pty Ltd, Eveleigh (AU)

(21) Appl. No.: 13/318,118

(22) PCT Filed: Apr. 28, 2010
(86) PCT No.: PCT/AU10/00487

§ 371 Date: Jan. 23, 2012

(30) Foreign Application Priority Data
Apr. 28, 2009 (AU) 2009901842

(51) Int. Cl. G08B 23/00; H04W 4/00; G06N 5/04

(52) U.S. Cl. 455/414.1; 706/52; 340/573.1

(57) ABSTRACT

A method for determining the likelihood of a medical event occurring, comprising the steps of applying a data mining technique to a dataset containing temporal patient data, wherein the data mining technique provides information regarding the likelihood of a medical event occurring.

### FIELD OF THE INVENTION

The present invention relates to a method and system for determining the probability of a medical event occurring. Embodiments of the invention find particular, but not exclusive, use as a predictive, alert or warning system for medical professionals.

### BACKGROUND OF THE INVENTION

Many hospitals provide a MET (Medical Emergency Team) service. A MET includes a number of medical professionals that are dedicated to the correct identification and treatment of unstable patients. The objective of the MET is to treat high risk patients and ideally prevent the onset of life threatening conditions such as a cardiac arrest.

A call to the MET is generally initiated by any member of hospital staff, based on some pre-defined criteria, such as the detection of an abnormality in a patient's vital signs. However, in practice, many MET calls are initiated simply because a medical professional is concerned about a patient. In some cases, the criteria used to identify a potentially unstable patient can be quite subjective. As such, MET resources and time can sometimes be inefficiently diverted into treating patients who are not at high risk of developing a life threatening condition.

Conversely, where hospitals and medical staff are overworked or under resourced, high risk patients may be overlooked. In some cases, by the time a patient is identified as high risk, it may be too late to prevent the onset of a life threatening condition. This can result in needless death or permanent disability of the patient.

### SUMMARY OF THE INVENTION

In a first embodiment, the present invention provides a method for determining the likelihood of a medical event occurring, comprising the steps of applying a data mining technique to a dataset containing temporal patient data, wherein the data mining technique provides information regarding the likelihood of a medical event occurring.

The dataset may contain historical pathology results for a plurality of patients and associated medical event information.

The data mining technique may determine a contrast pattern, to thereby provide information regarding the likelihood of the medical event occurring.

The probability of the medical event occurring may also be calculated.

The dataset may be pre-processed to group the data in a format which assists in the application of a data mining technique.

The pre-processing may include at least one of the steps of aggregating at least one type of data value over a given period of time to reduce the number of data values in the data set, removing data values not utilised in the determination of the likelihood of a medical event occurring, removing erroneous data values from the dataset and/or aggregating the data in the dataset into a critical and a non-critical temporal period.

The critical temporal period may be defined as a period of time within 24 hours of a patient experiencing a medical event.

The data mining technique may be applied on a sub-set of the patient data and the subset may be chosen utilising at least one of an inclusive sampling methodology, a randomly chosen sampling methodology, and a temporal sampling methodology.

The information may be tested against a known data set to determine the reliability of the information.

The information may be utilised to determine a set of predictors, wherein the predictors may be compared against individual patient data to provide an indicator of the likelihood of an adverse medical event occurring.

An alert may be provided if the indicators exceed a predetermined threshold. The alert may be a message sent to a device which is physically proximate to a medical professional or a patient, such as a mobile telephone.

In a second embodiment, the present invention provides a system for determining the likelihood of a medical event, comprising a data mining module arranged to query a dataset containing temporal patient data, wherein the data mining module outputs information regarding the likelihood of a medical event occurring.

In a third embodiment, the present invention provides a computer programme including at least one instruction which, when executed on a computing system, performs the method steps of the first embodiment of the invention.

In a fourth embodiment, the present invention provides a computer readable medium incorporating a computer programme in accordance with the third embodiment of the invention.

In a fifth embodiment, the present invention provides a data signal encoding at least one instruction which, when executed on a computing system, performs the method steps of the first embodiment of the invention.

### DETAILED DESCRIPTION OF THE DRAWINGS

Notwithstanding any other forms which may fall within the scope of the present invention, a preferred embodiment will now be described, by way of example only, with reference to the accompanying drawings in which:

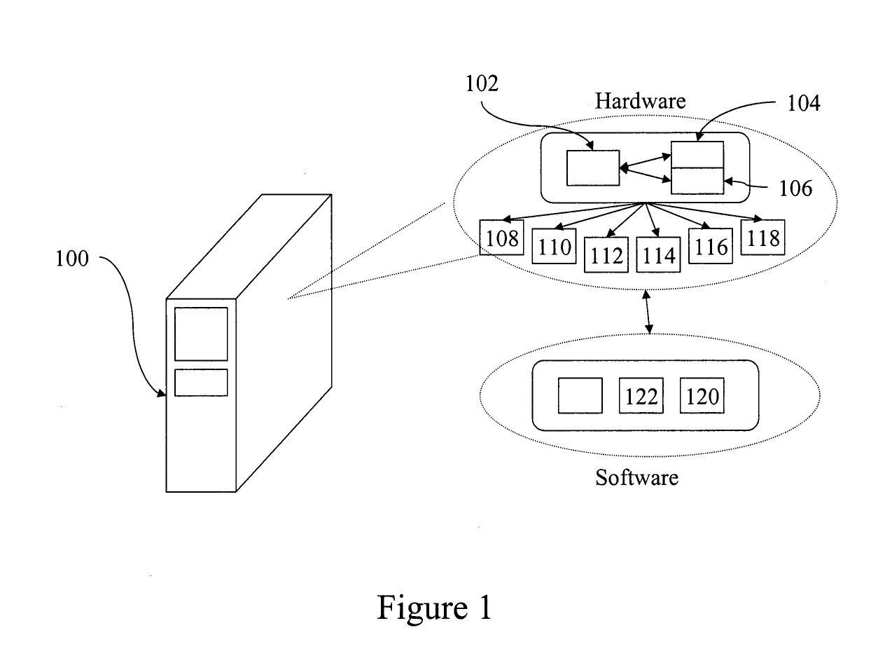

FIG. 1 is a diagram depicting a computing system suitable for operation of a software application in accordance with an embodiment of the present invention;

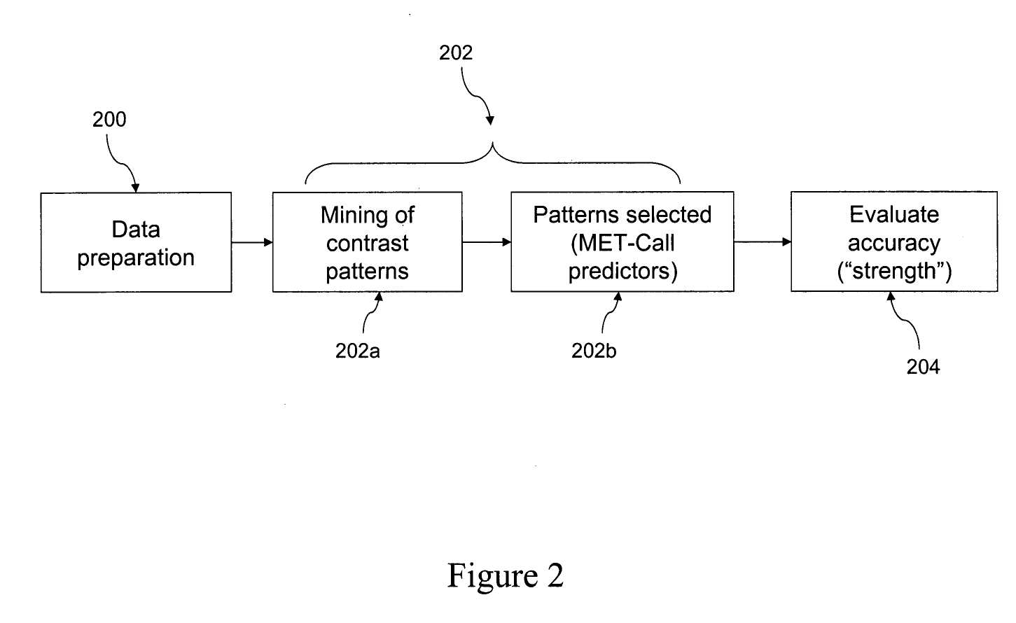

FIG. 2 is a flowchart illustrating a method for determining the probability of a medical event occurring, in accordance with an embodiment of the present invention; and

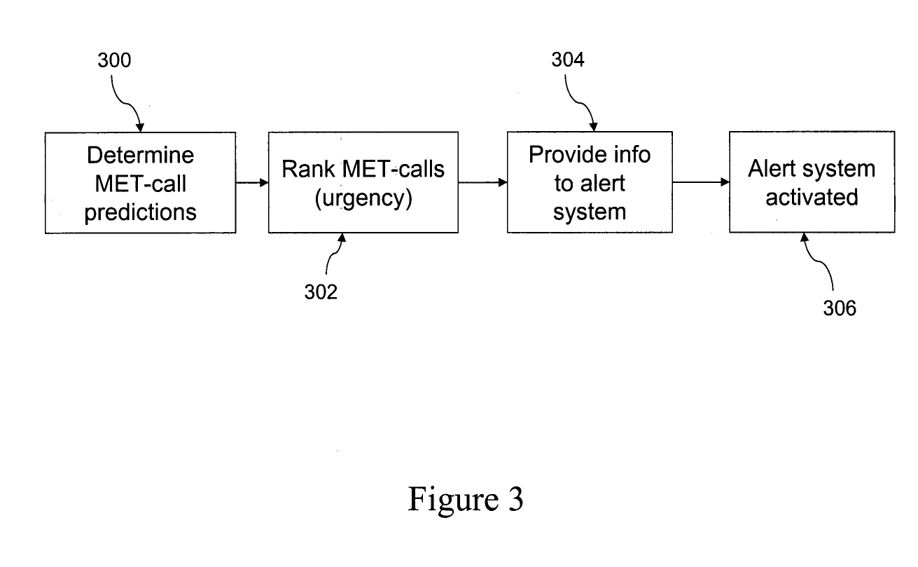

FIG. 3 is a flowchart illustrating the operation of an alert system in accordance with an embodiment of the present invention.

### DESCRIPTION OF SPECIFIC EMBODIMENTS

At FIG. 1 there is shown a schematic diagram of a computing system 100 suitable for use with an embodiment of the present invention. The computing system 100 may be used to execute applications and/or system services such as a corporate compliance and reporting system and/or method in accordance with an embodiment of the present invention. The computing system 100 preferably comprises a processor 102, read only memory (ROM) 104, random access memory (RAM) 106, and input/output devices such as disk drives 108, keyboard 110, mouse 112, display 114, printer 116, and communications link 118. The computer includes programs that may be stored in RAM 106, ROM 104, or disk drives 108 and may be executed by the processor 102. The communications link 118 connects to a computer network such as the Internet but may be connected to a telephone line, an antenna, a gateway or any other type of communications link. Disk drives 108 may include any suitable storage media, such as, for example, floppy disk drives, hard disk drives, CD ROM drives or magnetic tape drives. The computing system 100 may use a single disk drive 108 or multiple disk drives. The computing system 100 may use any suitable operating systems, such as Windows™ or Unix™.

It will be understood that the computing system described in the preceding paragraphs is illustrative only, and that an embodiment of the present invention may be executed on any suitable computing system, with any suitable hardware and/or software.

In one embodiment, the present invention is implemented as a software application 120 arranged to be executable on the computing system 100, the software application interacting with a database 122, such as a SQL (Structured Query Language) database and being accessed via one or more remote terminals (not shown).

### System Overview

A specific embodiment of the present invention provides a system and method for predicting the likelihood (probability) of a patient experiencing a medical event in the short to medium term. In particular, the invention finds use in the prediction of adverse medical events, such as cardiac arrest, such that a MET-call may be initiated within a suitable time.

The embodiment described herein utilises a multi stage process, where each stage may be performed separately, or may be integrally performed by a single software application. The embodiment utilises a plurality of patients' pathology profiles and other diagnostic information such as disease and procedure codes stored within an electronic health record to determine robust predictors of a medical event (and therefore the need for a MET-call). Once the predictors are determined, the predictors may then be passed to a medical/hospital database programme, which is arranged to extract current (“live”) patient data from the database and compare it to the predictors. In turn, the programme can identify patients that are at risk of experiencing an adverse medical event within a given period of time. Identified patients can then be brought to the attention of relevant medical professionals (e.g. a MET-call team member), so that preventative action may be taken, thereby greatly increasing the likelihood of either avoiding or ameliorating the adverse medical event.

As such, the embodiment described herein may be considered to have at least two components:

1. A data mining/contrast pattern determination component; arranged to derive appropriate predictors; and

2. A database interface component, arranged to check against existing patient data to determine whether a medical professional should be alerted to the possibility of an adverse medical event occurring.

### Determination of One or More MET-Call Predictors

At a broad level and referring to the first component (as outlined above and which is described in more detail below) a data mining technique referred to as “emerging patterns” (or “contrast patterns”) is utilised to identify strong differentiators between two groups of data. In more detail, MET-call predictors based on contrast patterns which strongly distinguish patients' conditions shortly prior to a MET-call are compared against patients' conditions in other periods.

In order to build a database of strong predictors, data was gathered from the Austin hospital (a public hospital based in Melbourne, Australia). The data was extracted from a pathology database for the years spanning 2000-2006 and included a log of activated MET-calls within that period.

Using the data, a number of steps were undertaken to process the data to derive a tangible predictor of patient instability (i.e. a “MET-call predictor”). The steps are outlined below, with reference to the flowchart of FIG. 2:

1. Data preparation (step 200)—Before a contrast pattern mining methodology can be employed, preparation steps are required to formulate a dataset which will be used for training the MET-call predictors. The preparation steps include a data cleaning step (200a) and a data summarisation step (200b);

2. MET-call Predictors Discovery (step 202)—Mining of contrast patterns is performed on the pre-processed training data (202a). A number of interesting patterns are selected and they formulate the MET-call predictors (202b); and

3. Prediction Strength Evaluation (step 204): Lastly, the prediction strength of the predictors to evaluate their prediction accuracy and robustness before they can be used in real-word scenarios.

Each of the above steps will be described in more details in the sections below.

### Problem Formulation for Finding MET-Call Predictors

A MET-call predictor can be defined as a condition (i.e. combination of pathology test results) which applies to a patient within a short period (e.g. 24 hours) prior to a MET-call event, but does not apply in an earlier time period. That is, a MET-call predictor can be viewed as a set of symptoms that, taken together, indicate that is highly probable that a patient will require a MET-call within 24 hours.

In the data mining context, such a predictor can be described by so-called Contrast Patterns, which are strong differentiators between two classes of data. By definition, contrast patterns are combinations of values which appear frequently in one class of data, but do not appear frequently in the other class of data.

As an overview of the mining technique, finding MET-call predictors involves the following 3 steps:

1. Training data formulation—A data cleaning procedure is used to remove the unnecessary test-values and erroneous entries. Subsequently, a data summarisation step is performed by firstly defining two time windows, labelled as CRITICAL and NON-CRITICAL periods. A CRITICAL period is defined as a short time period prior to a MET-call (e.g. 24 hours prior to a MET-call), and a NON-CRITICAL period is defined as a time period prior to the CRITICAL period.

For each patient, the records within each period are grouped and aggregated, forming a summarised CRITICAL training record and a summarised NON-CRITICAL training record;

2. MET-call predictors discovery—Given the training dataset, conditions which apply to many of the CRITICAL records, but do not apply in many of the NON-CRITICAL records are discovered.

The predictor has the following form:
If <condition> applies to a patient, then the patient is in a CRITICAL period, i.e. a MET-call is likely to occur within the next 24-hours, where <condition> is a contrast pattern.

To find useful and predictive patterns, selection criteria must be chosen. The selection criteria include the minimum/maximum frequency threshold of the patterns, and the methodology for testing their statistical significance; and

3. Prediction strength evaluation—This task requires a design of methodology of how the MET-call predictors are used to make a prediction, and how the prediction strength is evaluated. A prediction can be using single MET-call predictors, or upon an ensemble of predictors. To evaluate the prediction strength of the MET-call predictors, a real-time scenario is simulated using the non-aggregated database and the predictors are tested by comparing against various time points in patients' history.

A failed MET-call is defined as the “death” event of a patient which is not preceded by a MET-call activation. In such a scenario, it is assumed that death could have been prevented if the MET-call had been activated. Predictors for failed MET-calls can be found by comparing the patients' profiles within the CRITICAL period of failed MET-calls against other periods (which include the NON-CRITICAL period of all MET-calls and CRITICAL period of successful MET-calls).

### Defining Contrast Patterns

To formally define contrast patterns, also known as emerging patterns, it is instructive to utilise the following terminology:
A database D is described by k discrete attributes, i.e. A₁, A₂ . . . Aₖ. Let dom(Aᵢ) be the domain of attribute values for attribute Aᵢ, where i is in the set [1, 2 . . . k], and I is the aggregated domain values from all attributes.
An itemset is a subset of I. Database D is a collection of transactions, where each transaction is an itemset.
Support of an itemset q in a dataset D, i.e. support(q,D) is the number of transactions which contain q. Suppose Dₚ be a positive dataset and Dₙ is a negative dataset, defined upon the same set of attributes and domain values. Given two support thresholds, α and β, an emerging pattern is defined an itemset whose support in Dₚ is at least α, and whose support in Dₙ is no more than β,
i.e. support (q,Dp)≧α and support (q,Dₙ)≦β. Furthermore, an emerging pattern is a minimal emerging pattern if none of its proper subsets is an emerging pattern.

Emerging patterns identify distinguishing characteristics in the positive class against the negative class. Thus, they can be used as predictors for the positive class. In this study, minimal emerging patterns are used as the predictors, which have been shown useful for building highly accurate classifiers.

Discovering strong predictors requires selecting the appropriate support constraints which define the contrast patterns. This takes iterative experiments to obtain emerging patterns with the following characteristics in order to allow easy interpretability by human experts:
Short (or general) patterns—general predictors are easier to interpret than more specific, longer, predictors (i.e. each predictor does not contain more than 4 items); and
Statistical significance testing—it may be the case that a given emerging pattern has low support in Dₚ, but its occurrence in the training dataset may be caused by some randomness, hence, it is not statistically significant.

### Data Preparation

As is the case in any real-world problem, the input pathology database and other databases of relevance is likely to contain a portion of erroneous values or missing values. Different pathology tests may be measured using different instruments or units, which may result in the need to re-scale or convert values. Moreover, not all patients have the same tests performed, and the tests are performed at different times and sometimes for different reasons.

Moreover, the pathology database consists of temporal valued attributes (i.e. each has an associated time value), yet current contrast pattern mining techniques have not been able to include such a temporal aspect. To overcome this problem, a data aggregation method is used to reduce the sparseness of the training data and also effectively provide temporal abstraction. In order to aggregate the data, a CRITICAL period is defined as the 24-hours prior to a MET-call, and a NON-CRITICAL period is defined as the period within 24-hrs and 7-days prior to a MET-call. Moreover, for each patient, the pathology data which falls within the two time frames, respectively, are grouped and aggregated (e.g. their average taken).

### CRITICAL Window Size

As the window size was chosen somewhat arbitrarily, further investigations were carried out to determine whether a particular CRITICAL window size was optimal or preferable when segmenting and aggregating the data. This was explored by utilising a number of different window sizes such as:
CRITICAL period: 0-48 hours prior to a MET call; NON-CRITICAL period: 48-168 hours prior to a MET call.
CRITICAL period: 0-24 hours prior to a MET call; NON-CRITICAL period: 24-168 hours prior to a MET call.
CRITICAL period: 0-12 hours prior to a MET call; NON-CRITICAL period: 12-168 hours prior to a MET call.
CRITICAL period: 0-6 hours prior to a MET call; NON-CRITICAL period: 6-168 hours prior to a MET call.

Using a smaller CRITICAL time period may result in data becoming unavailable for some patients since some tests may not be performed (and/or become available) within a short time prior to a MET-call event.

For each of the above window sizes, the records within each period are aggregated by calculating the average value. To evaluate the predictors' strength using a varied CRITICAL window sizes, each rule is evaluated using the following metrics:
Frequency=the fraction of MET-calls which are called for patients who have the condition, out of all MET-calls in the database.
Accuracy=the fraction of patients who have a MET-call shortly after they have the condition, out of all patients who have the conditions.
Positive Occurrence=the number of patients who have the condition and have a MET-call shortly after (=absolute frequency).
Positive Applicability=the number of patients who have the relevant test(s), which are included in the rule's condition, performed and a MET-call occurs;
Negative Occurrence=the number of patients who have the condition but do not have a MET-call;
Negative Applicability=the number of patients who have the relevant test(s), which are included in the rule's condition, performed but do not have a MET-call; and
Risk Ratio, RR=Frequency/Negative Frequency, where Negative Frequency is the fraction of patients who have the rule's condition but a MET-call does not occur.

A particular window size may result in a more or less sparse training dataset, which in turn has an impact on the predictor's accuracy. For instance, a predictor's accuracy may be increased because the value range in its condition has changed, or because there are fewer patients who have the tests performed within the selected CRITICAL time period.

Moreover, other than calculating an average, other techniques are also utilised to obtain the aggregated training records:
Median: This function seems to be more suitable, than calculating the average, for attributes whose values are not normally distributed. The median of the grouped CRITICAL records is calculated instead of the average; and
Sub-period splitting: The initial NON-CRITICAL period definition is allowed to have a different size than the CRITICAL period. This may result in a distorted data summarisation as the CRITICAL and NON-CRITICAL training records actually represent aggregated values of different time-window sizes.

Under this aggregation function, the NON-CRITICAL period is split into equal-intervals of sub-periods; each sub period is represented by one NON-CRITICAL summarised record.

### Varying the Size of the CRITICAL Window

Different rules (i.e. predictors) are uncovered depending on the CRITICAL window size. A number of new strong rules are found when the smaller window is used which are not found in the larger window setting. Some of the rules are found to be similar when different windowing parameters which test the same attribute(s) are compared. However, the value range of their condition may be changed, which in turn changes their accuracy.

More particularly, some rules have lower accuracy when they are mined under a smaller CRITICAL window size. In general, smaller CRITICAL periods increase the sparseness of the CRITICAL training records, especially for pathology tests which are rarely performed. On the other hand, stronger contrast patterns are found when utilising a smaller CRITICAL period, which can give rise to more accurate predictors. In other words, no single CRITICAL window size can discover uniformly better predictors. Each WINDOW size is capable of uncovering different rules.

Of course, if a “perfect” dataset were available (i.e. a dataset where sparseness is not an issue), then it will be understood that a smaller CRITICAL window size would potentially yield more accurate results.

### Varying the Data Aggregation Function

For many of the rules which are found from both the median as well as the mean values, the rules have both higher frequency and accuracy when the median values are used. Moreover, new attributes appear in strong median-valued rules which do not appear as strong mean-valued rules. In general, the median-valued rules have higher frequency because they are applicable to more training records than the mean-valued rules.

However some rules are also more applicable to the NON-CRITICAL records which reduce their accuracy.

These results indicate that the median-valued rules are less powerful to describe the contrast characteristics between the CRITICAL and NON-CRITICAL records as opposed to the mean-valued rules, except for a few exceptional pathology tests which are only discovered in median-valued contrast patterns.

Splitting the NON-CRITICAL period into equi-width sub-periods is intended to produce more meaningful data summarisation. In one example, the CRITICAL period may be chosen as the time period 0-24 hours prior to a MET call, and the NON-CRITICAL period is the time period 24-72 hours prior to a MET call and equally split into 24-hr intervals, i.e. 24-48 hrs, 48-72 hrs prior to a MET call. Under this aggregation schema, each aggregated CRITICAL, as well as NON-CRITICAL, record is an average of values within some 24-hour interval. Thus, the aggregation has finer temporal granularity and is more accurate than the naive, non-splitting aggregation function.

As an implication, the number of NON-CRITICAL training records is increased, which in turn, makes it harder to find strong contrast patterns. If a rule which is found using the basic aggregation schema also occurs in NON_CRITICAL records with a relatively high accuracy, then it is highly likely that the rule will be accurate and reliable.

Applying sub-period aggregation in finding the contrast patterns of failed MET-calls in comparison to the successful MET-calls: the CRITICAL period from either a successful or a failed MET-call is split into equi-width sub-periods (similar to the second schema). To make use of this aggregation schema, aggregation is performed by taking the value differences between those sub-periods. In this aggregation schema, the relative change of the average values between the sub periods from a given CRITICAL period is calculated and used for identifying the contrast patterns.

Therefore, the rule would be:
If average(pH) within 24-0 hours prior to a MET-call is higher by 0.3 than the average(pH) in the previous day (48-24 hours prior to the MET-call), then the MET-call is likely to fail.

To obtain the training dataset, the average from each sub-period from a given CRITICAL period is calculated, and then the averages are subtracted to obtain a relative change of the average. This calculation is performed for each failed MET-call to formulate the positive dataset, and for each successful MET-call to formulate the negative dataset, and finally, contrast patterns are mined on this dataset.

This effectively increases the number of training records in both the positive and the negative training records. The rare attributes make more missing values in the training dataset, whereas the frequently tested attributes will have values in more training records. Fewer rules are discovered using this aggregation schema, many of them have lower risk ratio although the relative accuracy and frequency are higher (because they are only applicable to fewer records).

### Testing MET-Call Predictions

To further test the robustness of the predictors, the following testing methodologies are utilised to calculate the strength of the discovered rules, from the raw (i.e. pre-aggregated) pathology database. This method is akin to simulating a real-time system which uses the discovered rules to predict whether a MET-call is likely to occur for a patient in the next short period of time at a given sampling point.

The short period prior to a patient's death a CRITICAL condition, for which a MET-call should be activated. A term called a missed MET-call is defined if a patient died without having a MET-call.

This allows more relevant predictions to be constructed, such as whether a MET-call is likely to occur, or a patient's death is likely to occur within the next short period of time.

In one approach, a MET-call is predicted to occur shortly if a sample satisfies the condition of the prediction rule(s). If it does, then those rules whose conditions are contained are applicable in the given sample. This is called a positive prediction. A parameter max time to MET is used to define the time boundary for the predicted MET-call to occur from the time when the rule is applicable to a patient.

Thus, if a MET-call occurs within the time boundary, or it does not occur but the patient dies within the time boundary, the sample is labelled as a positive sample. The number of positive predictions which are made for positive samples is called correct positive prediction. On the other hand, the number of negative predictions which are made for positive samples is called the false negative prediction.

### Data Sampling

Three methodologies were developed to form the testing dataset, with the second and the third methodologies being aimed to reduce the prediction's sensitivity to sampling bias. For instance, some group of records whose timestamps are very close together are likely to induce the same prediction.

1. Inclusive sampling: The first methodology uses every sample in the pathology database as a test case.

2. One-third sampling: The second methodology uses a portion of the pathology database, i.e. one-third of the entire database, and the records are randomly chosen.

3. Bucket sampling: The third methodology uses one-sample-per-day for each patient. This methodology randomly chooses a sample from each day in the pathology database.

### Decision Making

In each of the above sampling methodologies, the decision on when to make a positive MET-call prediction is considered in two aspects:
(i) the applicability of a predictor in a given test case; and
(ii) how the MET-call predictors are used to make a decision.

The following two schemas are used for counting the applicability of a prediction rule in a given test case:

1. The test case simply contains the rule's condition. This kind of condition is relatively strict as the individual data samples may not have a value for the particular condition (i.e. pathology test).

2. Aggregate (e.g. by calculating their average) some records prior to and including the test case, from the same patient, and find whether the aggregated record satisfies the rule's condition. A pre-defined target window size is chosen, to determine how many records are to be included in the aggregation.

By default, the target window size is the same as the size of the CRITICAL period which is used for training the predictors.

To decide whether a POSITIVE MET-call prediction should be made: either a single predictor or an ensemble of multiple predictors can be used.
Single Predictor: The first approach finds at least one applicable MET-predictor (according to the above applicability testing) for the test case.
Multiple Predictors: The latter uses a class-tournament schema. In this schema, MET-call predictors for both the CRITICAL as well as the NON-CRITICAL records are firstly mined. Then, a score is calculated for each class as the sum of accuracies of all applicable predictors and a positive prediction is made if the sum of the score of the applicable positive predictors (i.e. predictors for the CRITICAL records) is higher than the applicable negative predictors (i.e. predictors for the NON-CRITICAL records).

### Prediction Scores

To calculate the strength of each prediction rule, a few metrics are used to measure the prediction accuracy of that rule, such as:

1. True positive prediction=the proportion of records which are followed by a MET-call soon after, out of those records (or aggregate of some records) where the rule contributes to a positive prediction.

2. False negative prediction=the proportion of records which are followed by a MET-call soon after, out of those records (or aggregate of some records) where the rule does not contribute to making a positive prediction.

3. F-measure=the harmonic mean between precision and recall. Precision is the ratio between true positive prediction and the number of positive predictions, while recall is the ratio between true positive prediction and the number of positive samples.

4. Time to predicted event=the average time difference between the time when the rule's condition occurs, and the time when the MET-call occurs after that.

### Results

The second and the third sampling methods described above are aimed at reducing the prediction's sensitivity to sampling bias. Using the second and the third sampling methods does not give higher prediction scores over the first sampling method. This is because there is a trade-off in using the two sampling methods, namely that the number of samples is reduced.

The second method of sampling utilises on average, only about 20% of the samples, whereas the third method takes about 75% of the samples (in the database utilised in this particular example). Being inclusive, the first sampling method is preferred over the others, as it can test the robustness of the predictors in the presence of sampling bias.

When testing a rule's applicability in the individual test samples, prediction accuracy is generally lower than that when it is tested in the aggregated samples. More particularly, the rule's accuracy is lower because it is harder for the individual samples, being sparser, to contain the rule's condition than the aggregated samples from some period of time in history. When an ensemble of multiple MET-call predictions are used to decide a positive or negative prediction, the overall recall is also improved over the recall when individual MET-call predictors are used.

### Rules Refinement

In the rules-refinement phase, the appropriate size of the CRITICAL time window is revisited. For instance, a MET-predictor is learnt with a CRITICAL period defined as 24-hours prior to a MET-call (with average aggregation function). By default, the target window size for such a predictor is 24-hours, i.e. it is tested upon the average values within the last 24-hours at any given sampling point. If the average values satisfy the predictor's condition, then a MET-call is predicted to occur shortly (i.e. within the next 24-hours) after. However, it may be the case that more correct predictions are made if the average values are taken from a different target window size. Hence, the objective of this particular task is to find the most appropriate target window size for the MET-call predictors.

A series of scores is obtained for each predictor, varied by the target window size. A number of target window sizes are used, between 2 and 48 hours, with 2 hours interval, i.e. 2, 4, 6, 8, . . . 48. For each window size, the MET-call predictors are tested upon the pre-aggregation samples, and the prediction scores (i.e. F-measure) of each predictor is calculated. Then, for each predictor, the strongest window size for which the prediction score is the highest is selected.

Lastly, the testing phase is repeated using an ensemble of the MET-predictors, with the strongest target window size for each predictor. The overall precision is significantly improved over the recall when individual MET-call predictors are used, achieving up to 80% recall (precision=12.87%, F-measure=0.2223). More specifically, only 580 out of 3124 MET-calls are missed by the prediction.

### MET-Call Predictors

In this section, there is provided a list of the set of rules which are found as statistically significant conditions which are likely to occur within 48-hours of a MET-call, but not likely to occur within 168-48 hours prior to a MET-call.

Based on some feedback from the medical experts at Austin Hospital, the rules, especially those which contain a single condition, generally reveal abnormal values of the particular pathology test, and also characterise some known diseases, such as a failure of kidney function. Interestingly, some of the other more specific rules reveal indicators which are previously unknown, such as the inclusion of gender as part of the predictors.

To evaluate their prediction strength, all samples in the database are used as a testing set. For each sample, the average values over some target window size are obtained. When predictions are made using an ensemble of all the rules and an optimised target window size, an overall 81.43% (2544/3124) of MET-calls or death events can be correctly predicted (12.87% correct prediction out of 19764 predictions, F-measure=0.2223). The following lists the prediction scores when the rules are used individually for predicting a MET-call.
Rule 1=pH≦7.28
Target window size=2 hours
Testing precision=49.51%
F-measure=0.2039
Time to predicted event=10.41 hours
Rule 2=CO2≧20.29
Target window size=6 hours
Testing precision=24.31%
F-measure=0.2795
Time to predicted event=13.66 hours
Rule 3=WCC>17.40
Target window size=42 hours
Testing precision=28.72%
F-measure=0.2826
Time to predicted event=13.85 hours
Rule 4=K>5.16
Target window size=2 hours
Testing precision=17.40%
F-measure=0.1887
Time to predicted event=10.24 hours
Rule 5=72.25<ALP≦85.08
Target window size=48 hours
Testing precision=14.03%
F-measure=0.0943
Time to predicted event=14.78 hours
Rule 6=ALP>256.50
Target window size=48 hours
Testing precision=16.74%
F-measure=0.1526
Time to predicted event=11.47 hours
Rule 7=93.75<Cl≦96.55
Target window size=12 hours
Testing precision=18.93%
F-measure=0.1915
Time to predicted event=21.26 hours
Rule 8=10.86<WCC≦12.22
Target window size=42 hours
Testing precision=20.51%
F-measure=0.1893
Time to predicted event=12.51 hours
Rule 9=ALP≧54.12
Target window size=48 hours
Testing precision=7.63%
F-measure=0.0425
Time to predicted event=15.72 hours
Rule 10=3.47<K≦3.70
Target window size=2 hours
Testing precision=11.02%
F-measure=0.0992
Time to predicted event=21.57 hours
Rule 11=156.25<Plat≦185.17
Target window size=24 hours
Testing precision=11.50%
F-measure=0.1075
Time to predicted event=8.87 hours
Rule 12=11.75<PT≦12.017
Target window size=18 hours
Testing precision=13.02%
F-measure=0.0742
Time to predicted event=22.30 hours
Rule 13=APTT>64.45
Target window size=24 hours
Testing precision=28.63%
F-measure=0.1126
Time to predicted event=12.97 hours
Rule 14=2.01<Ca≦2.07
Target window size=18 hours
Testing precision=34.06%
F-measure=0.1664
Time to predicted event=10.86 hours
Rule 15=193.75<CK≦344.50
Target window size=48 hours
Testing precision=41.77%
F-measure=0.1302
Time to predicted event=11.07 hours
Rule 16=7.28<pH≦7.33, and
21.17<hCO3≦23.12
Target window size=2 hours
Testing precision=51.06%
F-measure=0.0151
Time to predicted event=18.31 hours
Rule 17=137.50<CK≦193.75, and
1.56<PO4≦2.01
Target window size=48 hours
Testing precision=2.86%
F-measure=0.0006
Time to predicted event=28.8 hours
Rule 18=7.3312<pH≦7.3605
3.8854<K≦4.0062
Target window size=6 hours
Testing precision=50%
F-measure=0.0019
Time to predicted event=5.63 hours
Rule 19=29.1667<hCO3≦32.1364
4.7583<K≦5.1583
Target window size=36 hours
Testing precision=21.24%
F-measure=0.0148
Time to predicted event=6.99 hours
Rule 20=pH≦7.2825
ALT≧10.1250
Target window size=42 hours
Testing precision=22.78%
F-measure=0.0219
Time to predicted event=19.02 hours
Rule 21=sex=Female
3.8854<K≦4.0062
22.2250<CO2≦23.5357
Target window size=36 hours
Testing precision=11.80%
F-measure=0.0231
Time to predicted event=6.17 hours
Rule 22=sex=Female
K>5.1583
301.1665<Plat≦348.2000
Target window size=24 hours
Testing precision=21.65%
F-measure=0.0326
Time to predicted event=12.063 hours
Rule 23=sex=Female
K>5.1583
32.1000<ALB≦35.1666
Target window size=48 hours
Testing precision=7.77%
F-measure=0.0096
Time to predicted event=15.28 hours
Rule 24=sex=Female
K>5.1583
109.1550<Hb≦115.0835
Target window size=24 hours
Testing precision=24.73%
F-measure=0.0272
Time to predicted event=5.95 hours
Rule 25=K>5.1583
U>21.0666
185.1665<Plat<212.1665
Target window size=24 hours
Testing precision=18.79%
F-measure=0.0171
Time to predicted event=18.94 hours
Rule 26=sex=Female
103.9375<Cl≦105.0835
53.5834<GGT≦74.2500
Target window size=2 hours
Testing precision=6.82%
F-measure=0.0019
Time to predicted event=6.45 hours

### Identifying Missed MET-Calls

As an extension, similar training and testing methodologies are applied to the larger set dataset, which contains all records for patients (not exclusively those who have had a MET-call) in 2000-2006.

Here, a larger database is utilised which includes data from other patients who do not have a history of MET-calls. Testing the MET-predictors on this large database effectively tests the robustness of the predictors in the presence of many negative samples.

The predictors learnt on MET-call patient data were used and it was found that the overall precision significantly dropped to only 1.5%, but it can still achieve a relatively high 60% recall (only reduced by 9% compared to when only the MET-call patients' data was used).

Then, the rule training process was repeated to find MET-call predictors using this large database and include the missed MET-calls category. For patients who do not have a MET-call, their time of death is considered as the time of a missed MET-call. The rules are shown in the following section. To obtain preliminary results, the prediction strength of each rule is evaluated using a 48-hour target window size.

### MET-Call or a Missed MET-Call Predictors

The conditions, based on the database herein before described, which have been found as predictors of a MET-call, are listed below. Due to the large size of the data, only a subset of the available pathology tests are considered. Those selected pathology tests are contained in the MET-call predictors which are learned earlier from the smaller database, containing only results from patients who have MET-call(s).

When a prediction is made using an ensemble method, a count of 1610 MET-call or death events are correctly predicted, out of a total of 6137 such events in the database (recall=26.23%, precision=3.27%, F-measure=5.82%).
Rule=pH≦7.3342
Target window size=48 hours
Testing precision=7.42%
Testing recall=16.16%
F-measure=10.17%
Time to predicted event=17.55 hours
Rule=K≧4.1708, and
CO2≧25.5500, and
TroplaxTroplbc>0.0317
Target window size=48 hours
Testing precision=4.33%
Testing recall=7.63%
F-measure=5.52%
Time to predicted event=20.26 hours
Rule=pH≦7.3342
hCO3≧25.1667
CK≦86.3750
Target window size=48 hours
Testing precision=7.87%
Testing recall=2.14%
F-measure=3.37%
Time to predicted event=15.64 hours
Rule=K≧4.1708
86.3750<CK≦20212.5000
TroplaxTroplbc>0.0317
Target window size=48 hours
Testing precision=3.22%
Testing recall=8.21%
F-measure=4.63%
Time to predicted event=21.20 hours
Rule=K≧4.1708
86.3750<CK≦20212.5000
PT>14.0500
Target window size=48 hours
Testing precision=4.82%
Testing recall=5.79%
F-measure=5.26%
Time to predicted event=21.19 hours
Rule=K≧4.1708
86.3750<CK≦20212.5000
APTT≧31.0500
Target window size=48 hours
Testing precision=2.41%
Testing recall=3.26%
F-measure=2.77%
Time to predicted event=18.56 hours
Rule=CO2≧25.5500
GGT>52.1666
PT>14.0500
APTT>31.0500
Target window size=48 hours
Testing precision=4.68%
Testing recall=9.31%
F-measure=6.23%
Time to predicted event=20.78 hours
Rule=K≧4.1708
CO2≧25.5500
86.3750<CK≦20212.5000
TroplaxTroplbc>0.0317
APTT≦31.0500
Target window size=48 hours
Testing precision=4.38%
Testing recall=1.56%
F-measure=2.30%
Time to predicted event=17.24 hours
Rule=pH≦7.3342
4.1708<K≦7.4750
CO2≧25.5500
TroplaxTroplbc≧0.0317
Target window size=48 hours
Testing precision=9.99%
Testing recall=1.72%
F-measure=2.94%
Time to predicted event=24.33 hours
Rule=pH≧7.3342
4.1708<K≦7.4750
CK≧86.3750
TroplaxTroplbc≧0.0317
Target window size=48 hours
Testing precision=9.53%
Testing recall=1.26%
F-measure=2.23%
Time to predicted event=23.14 hours
Rule=pH≦7.3342
hCO3≧25.1667
4.1708<K≦7.4750
TroplaxTroplbc≧0.0317
Target window size=48 hours
Testing precision=9.65%
Testing recall=1.62%
F-measure=2.78%
Time to predicted event=23.71 hours

### Implementation as a Warning/Alert System

As has been described earlier, embodiments of the present invention derive contrast patterns from a large historical patient data set and construct a series of MET-call predictors which predict a set of conditions (and an associated likelihood/probability) under which a patient will require a MET-call within a defined period of time.

Once these predictors are derived, in one embodiment, they are provided to a database programme which is arranged to access and draw data from a medical/hospital database. The database programme then utilises the predictors and patient data extracted from the medical/hospital database to determine the status of individual patients held at the hospital.

It will be understood that the hospital database (and by inference, the database programme) may use conventional or accepted codes or languages to describe patient types and conditions. For example, hospital database information such as historical discharge coding data held as ICD10 AM codes (an Australian system; http://nisweb.fhs.usyd.edu.au/ncch_new/2.aspx), Snomed CT codes (see http://www.ihtsdo.org/snomed-ct/) or similar digital coding information could be utilised by the database programme and the database, to allow an efficient and easy interchange of information between the hospital's main patient database and an embodiment of the present invention. It will be further understood that in another embodiment, the present invention may be integrated into an existing hospital database, to allow for seamless operation between the hospital patient database and the alert system.

If it is found that any patients are in danger or likely to require a MET-call within a defined period of time (say 48 hrs), an appropriate alert is sounded (e.g. a member of the MET may be paged or otherwise called) and the patient can be attended to before they experience a life threatening medical event.

In more detail and referring to FIG. 3, at step 300, a determination is made as to which patients have a high probability of requiring a MET-call within a defined period of time. At step 302, the patients are ranked in terms of urgency (i.e. those with the highest probability of requiring a MET-call are placed at the front of the queue). At step 304, the information is provided to an alert system arranged to notify (alert) appropriate personnel, such as a medical professional, to the need for a MET-call. At step 306, the alert is carried out, so that the medical professional is informed of the need for a MET-call.

In one embodiment, the alert may simply be displayed on a computing screen associated with the computing system on which the database programme resides and is executed (or a computing system which shares a common network with the computing system on which the database programme resides and is executed). Alternatively, the computing system may provide an alert in the form of a “red” or warning light located externally of the computing system and which is proximate to the patient in question (e.g. above the patient's bed). Such a system finds use in situations where the database programme is co-located near the patients listed in the database (e.g. within a casualty or MET ward in a hospital). Such visible alerts are difficult to ignore or overlook, thereby alerting medical professionals that may not have the time to check or review information displayed on a conventional computing system.

In another embodiment, which is arranged for hospitals where medical staff may be scarce or otherwise engaged in other activities, the database programme is arranged to interface with a Short Message Service (SMS) Gateway attached to a 2^{nd} or 3^{rd} Generation cellular telecommunications system, which is capable of automatically constructing and sending messages to mobile (“cell”) phones or pagers, which are generally carried by MET-call team members at all times.

The SMS gateway, upon receipt of an alert, may first check against a list of available MET-call team members, such that only MET-call staff which can physically attend are alerted. For example, upon arriving at the hospital, a MET-call team member may be required to “log in” (or otherwise identify their presence and availability in the hospital), such that the database programme is aware of their availability.

Other more sophisticated systems, such as automatic interfacing with a security access system (i.e. a system that tracks the movement of authorised personnel throughout a building or complex) may also be employed. For example, when a MET-call team member arrives for work and they “swipe” their access card (e.g. a magnetic or RFID access card) and enters a secure area, a message is sent to the database programme to place the MET-call team member on the “available” list. Once this occurs, the database programme can choose an available MET-call team member at random (or from a predetermined sequential order) from the list, and utilise the SMS gateway to send an alert to the MET-call team member.

It will be understood that, depending on hospital protocol and/or professional standards, there may be a requirement for medical professionals to acknowledge that they have received the alert and/or have acted on the alert. For example, the medical professional may need to send a return SMS message, or press a physical switch or button to disable the alert. In another embodiment, the system may continue to provide reminders (such as reactivating the alert or sending further SMS messages) until the medical professional acknowledges the alert. In yet another embodiment, if the alert is not acknowledged within a certain amount of time, the programme may be arranged to send the alert to another medical professional, such as another doctor or nurse. Such systems may be implemented to ensure that the possibility of an alert being overlooked or ignored is reduced.

Returning to the step of comparing patient data against the predictors, the database programme may perform checks against current patient data in any appropriate manner. For example, in one embodiment, a check is performed against patient data each time new information about the patient becomes available. That is, if a patient is registered in the system and a medical professional enters some new data regarding the patient's vital signs (e.g. the results of a blood test), the database programme is prompted to compare the predictors against the updated patient history, to determine whether there has been any change in the patient's vital signs which may warrant a MET-call.

In a different embodiment, the database programme may periodically (i.e. independent of any external event) compare all data for all patients currently registered in the hospital against the predictors, to determine whether any potential MET-calls are likely to arise within a given period of time. Alternatively, such a system may be run manually (i.e. rather than periodically, a medical professional may initiate a scan through all current patients and the medical professional may be presented with a list of patients which have a high probability of requiring a MET-call within a given period of time).

In yet another embodiment, the medical database may be interfaced with the data mining software, such that when a certain amount of new patient data is entered into the hospital/medical database, the data mining software re-creates (or refines) the predictors. That is, in some embodiments, there may be provided a feedback mechanism, where the “live” patient database is utilised to periodically update the predictors against which currently enrolled patients are tested, by reconstructing the rule set from the new enlarged database of data.

The embodiment may also include a facility to mark or exclude events where predictions are found to be incorrect. That is, where it is found that there is a systematic error in the MET-call predictors, or where a medical professional believes that new data may incorrectly skew the predictors, the medical professional may have the ability to mark such anomalous data, either for further study or for permanent exclusion from the data that is utilised to derive the predictors.

It will also be understood that the data mining software may reside on a central server, and draw data, either in real time or in periodic samples, from a plurality of medical/hospital databases. This allows the data mining software to constantly refine the predictors based on a very large (and therefore more reliable) data set. The refined predictors may then be periodically downloaded from the server to the medical/hospital databases, where they may be used locally to predict the possibility/frequency of MET-calls for individual patients within the hospital.

In other words, the data mining software may operate either:

1. Completely independently from any hospital/medical database or programme;

2. In conjunction with one or more hospital/medical databases or programmes (as described above); or

3. In a completely integrated manner with a hospital/medical database or programme.

In addition, each of the three embodiments described above may automatically update the MET-call predictors on a periodic basis.

### Advantages

As can be seen from the embodiment described above, a set of statistically significant rules can be identified using contrast patterns in the MET-call related data. These rules were discussed with the clinicians at Austin Hospital, and it was found that a majority of the derived rules were consistent with expert opinion.

In addition, the use of a post-processing method to refine the rules and optimise the predictors results in an increase in the accuracy of prediction. It was found that up to 60%-80% of all high-risk conditions (i.e. MET-call or death events) which occur in the database were correctly identified.

As such, the embodiment described herein provided a viable and useful tool for assisting medical professionals in both identifying potentially unstable patients and also, more importantly, in prioritising patients depending on the relative likelihood of a medical event occurring within a defined period of time. This allows for better patient care, lower mortality rates and more efficient use of hospital and medical resources.

### Alterations and Modifications to the Embodiments

It will be understood that further services may be added to the embodiments described herein without departing from the broader invention which is disclosed herein. For example, the software application may also be arranged to provide other incidental reporting or patient data utilised by medical professionals. Such variations and modifications are within the purview of a person skilled in the art.

In the preceding description, reference has been made to both “medical professionals” and “MET-call team members”. It will be understood that such terms are used to provide the reader with some guidance as to a likely user of the system, but should not be construed as placing a limit on the scope or application of the broader invention taught herein. The terms “medical professional” and “MET-call team member” may include, but are not limited to, doctors, nursing staff, employees of the hospital (irrespective of their qualifications or expertise in the medical area) or any other person whose duty is to care for or oversee the welfare of a patient.

In the preceding embodiments, reference has been made to one or more software applications. It will be understood that the software applications herein described may be written in any appropriate computer language, and arranged to execute on any suitable computing hardware, in any configuration. The software applications may be a stand-alone software application arranged to operate on a personal or server computer, or a portable device such as laptop computer, or a wireless device, such as a tablet PC or a PDA (personal digital assistant).

The software applications may alternatively be arranged to operate on a central server or servers. The application may be accessed from any suitable remote terminal, through a public or private network, such as the Internet.

Where the software application interfaces with another computing system or a database, the data may be communicated via any suitable communication network, including the Internet, a proprietary network (e.g. a private connection between different offices of an organisation), a wireless network, such as an 802.11 standard network, or a telecommunications network (including but not limited to a telephone line, a GSM, CDMA, EDGE or 3G mobile telecommunications network, or a microwave link).

It will also be understood that the embodiments described may be implemented via or as an application programming interface (API), for use by a developer, or may be implemented as code within another software application. Generally, as software applications include routines, programs, libraries, objects, components, and data files that perform or assist in the performance of particular functions, it will be understood that a software application may be distributed across a number of routines, programs, libraries, objects and components, but achieve the same functionality as the embodiment and the broader invention claimed herein. Such variations and modifications would be within the purview of those skilled in the art.

The foregoing description of the exemplary embodiments is provided to enable any person skilled in the art to make or use the present invention. While the invention has been described with respect to particular illustrated embodiments, various modifications to these embodiments will be readily apparent to those skilled in the art, and the generic principles defined herein may be applied to other embodiments without departing from the spirit or scope of the invention.

The present embodiments are, therefore, to be considered in all respects as illustrative and not restrictive.

1. A method for determining the likelihood of a medical event occurring, comprising the steps of applying a data mining technique to a dataset containing temporal patient data, wherein the data mining technique provides information regarding the likelihood of a medical event occurring.

2. A method in accordance with claim 1, wherein the dataset contains pathology results for a plurality of patients and associated medical event information.

3. A method in accordance with claim 1, wherein the data mining technique determines a contrast pattern, to thereby provide information regarding the likelihood of the medical event occurring.

4. A method in accordance with claim 3, comprising the further step of calculating the probability of the medical event occurring.

5. A method in accordance with claim 1, wherein the dataset is pre-processed to group the data in a format which assists in the application of a data mining technique.

6. A method in accordance with claim 5, wherein the pre-processing includes the step of aggregating at least one type of data value over a given period of time to reduce the number of data values in the data set.

7. A method in accordance with claim 5, wherein the pre-processing includes the step of removing data values not utilised in the determination of the likelihood of a medical event occurring.

8. A method in accordance with claim 5, wherein the pre-processing includes the step of removing erroneous data values from the dataset.

9. A method in accordance with claim 2, wherein the pre-processing includes the step of aggregating the data in the dataset into a critical and a non-critical temporal period.

10. A method in accordance with claim 9, wherein the critical temporal period is defined as a period of time within 24 hours of a patient experiencing a medical event.

11. A method in accordance with claim 1, comprising the further step of performing the data mining technique on a sub-set of the patient data.

12. A method in accordance with claim 11, wherein the subset is chosen utilising at least one of an inclusive sampling methodology, a randomly chosen sampling methodology, and a temporal sampling methodology.

13. A method in accordance with claim 1, comprising the further step of testing the information against a known data set to determine the reliability of the information.

14. A method in accordance with claim 1, comprising the further step of utilising the information to determine a set of predictors, wherein the predictors may be compared against individual patient data to provide an indicator of the likelihood of an adverse medical event occurring.

15. A method in accordance with claim 14, comprising the further step of providing an alert if the indicators exceed a predetermined threshold.

16. A method in accordance with claim 15, wherein the alert is a message sent to a device which is physically proximate to a medical professional or a patient.

17. A method in accordance with claim 16, wherein the device is a mobile telephone.

18. A system for determining the likelihood of a medical event occurring, comprising a data mining module arranged to query a dataset containing temporal patient data, wherein the data mining module outputs information regarding the likelihood of a medical event occurring.

19. A system in accordance with claim 18, wherein the dataset contains pathology results for a plurality of patients and associated medical event information.

20. A system in accordance with claim 18, wherein the data mining module determines a contrast pattern, to thereby provide information regarding the likelihood of the medical event occurring.

21. A system in accordance with claim 20, wherein the data mining module further calculates the probability of the medical event occurring.

22. A system in accordance with claim 18, wherein the dataset is pre-processed by a pre-processing module to group the data in a format which assists in the application of a data mining algorithm.

23. A system in accordance with claim 22, wherein the pre-processing module further aggregates at least one type of data value over a given period of time to reduce the number of data values in the data set.

24. A system in accordance with claim 22, wherein the pre-processing module further removing data values not utilised in the determination of the likelihood of a medical event occurring.

25. A system in accordance with claim 22, wherein the pre-processing module further removes erroneous data values from the dataset.

26. A system in accordance with claim 19, wherein the pre-processing module further aggregates the data in the dataset into a critical and a non-critical temporal period.

27. A system in accordance with claim 26, wherein the critical temporal period is defined as a period of time within 24 hours of a patient experiencing a medical event.

28. A system in accordance with claim 18, wherein the data mining module utilises only a sub-set of the patient data.

29. A system in accordance with claim 28, wherein the subset is chosen utilising at least one of an inclusive sampling methodology, a randomly chosen sampling methodology, and a temporal sampling methodology.

30. A system in accordance with claim 18, further comprising a testing module arranged to test the information against a known data set to determine the reliability of the information.

31. A system in accordance with claim 18, wherein the information is further processed by the data mining module to determine a set of predictors, wherein the predictors may be compared against individual patient data to provide an indicator of the likelihood of an adverse medical event occurring.

32. A system in accordance with claim 31, further comprising an alert module arranged to provide an alert if the indicators exceed a predetermined threshold.

33. A system in accordance with claim 32, wherein the alert is a message sent to a device which is physically proximate to a medical professional or a patient.

34. A system in accordance with claim 33, wherein the device is a mobile telephone.

35. A computer programme including at least one instruction which, when executed on a computing system, performs the method steps of claim 1.

36. A computer readable medium incorporating a computer programme in accordance with claim 35.

37. A data signal encoding at least one instruction which, when executed on a computing system, performs the method steps of claim 1.
